(19) United States
(12) Patent Application Publication
(10) Pub. No.: US 2006/0208118 A1
(43) Pub. Date: Sep. 21, 2006

(54) Blade holder in a chipping device, having blade carriers that rotate during ongoing operation

(76) Inventors: Wolfgang Holzer, Wallhalben (DE); Thomas Freichel, Lebach (DE)

Correspondence Address: WILLIAM COLLARD;COLLARD & ROE, P.C., 1077 NORTHERN BOULEVARD, ROSLYN, NY, 11576, US

(21) Appl. No.: 11/338,158

(22) Filed: Jan. 24, 2006

(30) Foreign Application Priority Data
Jan. 24, 2005 (DE) 10 2005 00 170.3

(51) Int. Cl. B02C 13/28

(52) U.S. Cl. 241/277

(57) ABSTRACT

A blade holder in a chipping device, has blade carriers that rotate in ongoing operation and blades attached to the blade carriers and being clamped in place with a clamping force via centrifugal forces that occur during rotation of the blade carriers in ongoing operation. The blades are attached to the blade carriers on a side that lies radially inward. There is at least one clamping element that lies radially inward of the blade carrier and is mounted on the blade carrier to rotate with the blade carrier. The clamping element exerts further clamping forces on the blade during rotation.

### BACKGROUND OF THE INVENTION

1. Field of the Invention

The invention relates to a blade holder in a chipping device, having blade carriers that rotate during ongoing operation.

2. The Prior Art

Such a blade holder is described, for example, in the patent DE 35 17 236 C2. There, the blades are attached on the radially outer side of the blade carriers. Furthermore, mass elements are present, which are pulled outward during rotation as the result of centrifugal force. These centrifugal forces are reversed in direction by way of a lever system, so that a clamping element presses onto the blades from above, and thereby presses the blades against the blade carriers with a clamping force.

### SUMMARY OF THE INVENTION

The present invention is based on the task of improving the blade holder.

This task is accomplished, according to the present invention, in that the blades are attached to the blade carriers on the side that lies radially inward, whereby at least one clamping element that lies radially inward is present, which element is mounted about a first point of rotation, and by means of which clamping forces are furthermore exerted on the blade during rotation.

It advantageously turns out, in the case of this solution, that the blades are pressed against the blade carrier directly, by means of the centrifugal forces, and not pulled away from it.

By means of the clamping element that lies radially inward, the result is achieved that the direction of the forces exerted by this clamping element does not have to be reversed.

The clamping element itself can have such a weight that the centrifugal forces that act on this clamping element are sufficient to press the blade against the blade carrier. The clamping element then only has to be mounted appropriately.

In one embodiment, the clamping element can be connected with additional masses, so that the centrifugal forces that act on the blade are increased. When using these additional masses, the clamping element can be structured in such a manner that it also makes a contribution to the centrifugal forces that are in effect, by way of its weight. Then, however, it is also possible to produce the centrifugal forces essentially only by means of the additional masses, and to then use the clamping element merely to transfer force.

By means of mounting the clamping element in a point of rotation, a lever effect can advantageously be achieved, with which the clamping force can be increased.

In another embodiment, the clamping element is mounted above the blade carrier by means of a tie rod, whereby the tie rod pulls the clamping element in the direction of the blade carrier by means of a spring-elastic bias.

It is advantageous if the clamping element is adjusted in the plane crosswise to the radial direction by means of the tie rod.

By means of the spring-elastic bias, a defined clamping force is furthermore achieved even if the rotor stands still. It can thereby prevent the blades from falling out unintentionally.

Furthermore, a blade replacement in the case of maintenance work can be implemented in simple manner, in that the clamping element is pressed away counter to the spring-elastic bias. The blade is then released and can be replaced in comparatively simple manner.

In one embodiment, at least one movable mass is connected with the tie rod in the region of the bearing part of the tie rod, in the radial direction. The centrifugal forces can be increased in this manner.

The tie rod can be guided in a bore, for example. In this connection, sufficient play must be present in the bore, in order to allow movement of the tie rod and the movable masses. The tie rod as well as the movable masses are not precisely moved in the longitudinal direction in the bore, because the tie rod is connected with the clamping element that is mounted in a point of rotation and therefore performs a rotary movement.

### BRIEF DESCRIPTION OF THE DRAWINGS

An exemplary embodiment of the invention is shown in the drawing. This shows:

FIG. 1 shows a first section through a blade carrier with a blade and a clamping element, and

FIGS. 2 and 3 show the arrangement according to FIG. 1 in other sectional planes.

### DETAILED DESCRIPTION OF THE PREFERRED EMBODIMENT

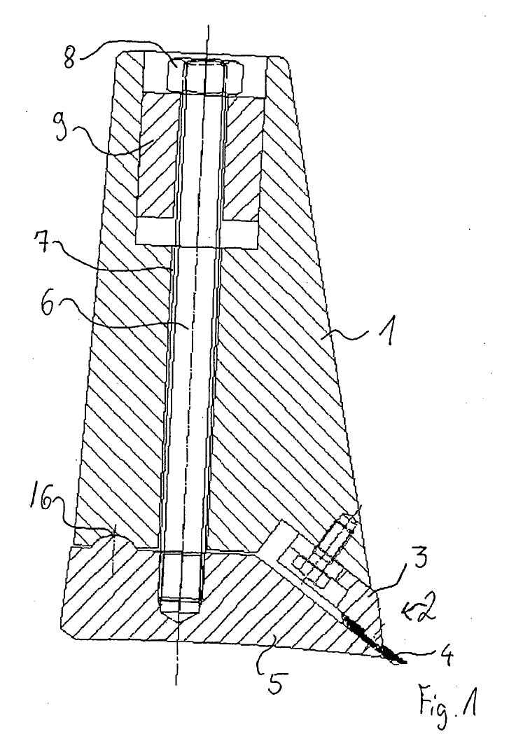

FIG. 1 shows a blade carrier 1 of a chipping device. Such chipping devices serve, in particular, to cut pieces of wood into small pieces, in order to produce chips from these pieces of wood. The blade carriers 1 are affixed along the circumference line of a rotor, which rotates during ongoing operation of the cut-up device, and thereby processes the pieces of wood to produce chips.

It can be seen that a cutting blade 2 is attached to the blade carrier 1. In the exemplary embodiment shown, this cutting blade 2 consists of a knife carrier 3 and a knife insert 4. It is also possible to configure the cutting blade 2 in one piece, so that the cutting blade 2 is then sharpened at defined maintenance intervals.

The cutting blade 2 is affixed on the side of the blade carrier 1 that lies radially inward.

Furthermore, a clamping element 5 can be seen, which is disposed on the side of the blade carrier 1 that lies radially inward. This clamping element 5 is mounted in such a manner that it can be rotated about a contact line 16. On the basis of the representation in the exemplary embodiment, the contact line 16 is a point in the representation shown.

During a rotation of the blade carrier 1 during ongoing operation, the clamping element 5 is pressed upward, in the direction of the drawing, as the result of the centrifugal forces that occur. Because of the rotating mounting of the clamping element 5, a clamping force is exerted on the cutting blade 2 as a result.

Furthermore, it can be seen that the clamping element 5 is held by means of a tie rod 6. This tie rod 6 holds the clamping element 5 and is guided through a bore 7 of the blade carrier 1. The tie rod 6 is held by the screw head 8. Furthermore, a movable mass 9 can be seen. The mass 9 is movable in the bore 7, in the longitudinal direction of this bore. By means of this mass 9, additional centrifugal forces are transferred to the clamping element 5 during operation of the cut-up device, by way of the tie rod 6.

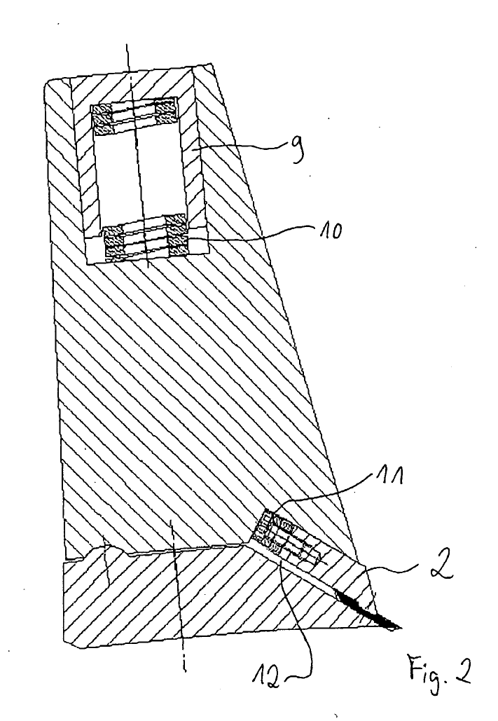

FIG. 2 shows another section through the blade carrier 1. There, it can be seen that the movable mass 9 is supported on the shoulder of the widened bore 7 by means of a spring 10. As a result, the clamping element 5 is biased when the chipping device is at rest. In the case of a blade replacement during maintenance work, the clamping element 5 can be pressed away counter to the spring force, so that the blade 2 can be replaced.

It can be seen from the representation of FIG. 2 that the blade 2 can be adjusted, in that screws 11 are disposed on its back side, as spacers, by way of which the distance of the blade from the back edge of the blade accommodation 12 can be adjusted.

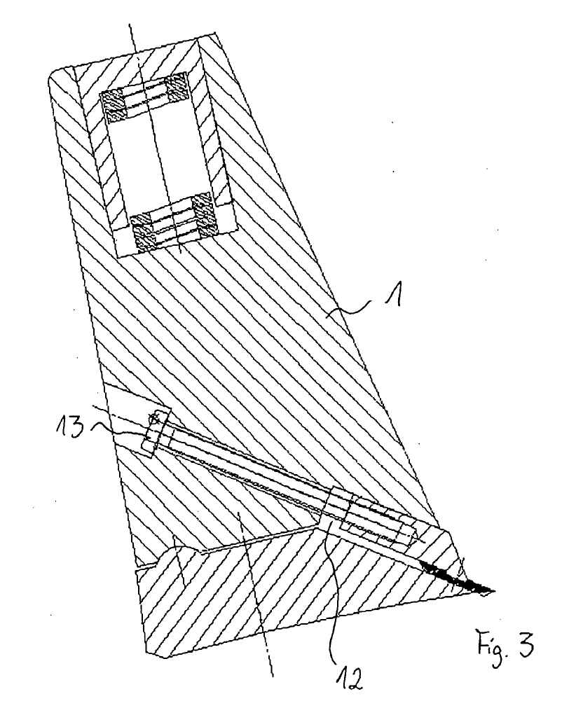

FIG. 3 shows the blade carrier 1 in another section. Here, a screw 13 can be seen, with which the blade 2 can be attached in the blade accommodation 12, for one thing. Furthermore, the distance that the blade 2 keeps from the back edge of the blade accommodation 12 is adjusted by means of the screw 13.

What is claimed is:

1. A blade holder in a chipping device, comprising:
blade carriers that rotate in ongoing operation;
blades attached to the blade carriers and being clamped in place with a clamping force via centrifugal forces that occur during rotation of the blade carriers in ongoing operation, said blades being attached to the blade carriers on a side that lies radially inward; and
at least one clamping element that lies radially inward of the blade carrier and is mounted on the blade carrier to rotate with the blade carrier, said clamping element exterting further clamping forces on the blade during rotation.

2. A blade holder according to claim 1, wherein the clamping element is mounted above the blade carrier by means of a tie rod, said tie rod pulling the clamping element in a direction of the blade carrier with a spring-elastic bias.

3. A blade holder according to claim 2, wherein there is at least one movable mass connected with the tie rod in a region of a bearing part of the tie rod, in a radial direction.
